(19) United States
(12) Patent Application Publication
(10) Pub. No.: US 2017/0119052 A1
(43) Pub. Date: May 4, 2017

(54) APPLICATION SPECIFIC INTEGRATED CIRCUIT (ASIC) FOR AN AEROSOL DELIVERY DEVICE

(71) Applicant: R.J. REYNOLDS TOBACCO COMPANY, WINSTON-SALEM, NC (US)

(72) Inventors: Rodney Owen Williams, Cary, NC (US); Raymond Charles Henry, JR., Cary, NC (US); Wilson Christopher Lamb, Hillsborough, NC (US); Frederic Philippe Ampolini, Winston-Salem, NC (US)

(21) Appl. No.: 14/928,584

(22) Filed: Oct. 30, 2015

(51) Int. Cl. A24F 47/00; H05B 3/00

(52) U.S. Cl. CPC A24F 47/008; H05B 3/0014

(57) ABSTRACT

An aerosol delivery device is provided that includes an application specific integrated circuit (ASIC) comprising system blocks designed to implement respective functions of the aerosol delivery device. The system blocks may include at least a battery management block configured to manage a battery configured to power the aerosol delivery device, a flow sensor interface block configured to detect the flow of air through at least the portion of the housing, and an excitation block configured to cause activation of the heating element in response to an input from the flow sensor interface block that indicates the detection of the airflow through at least the portion of the housing.

### TECHNOLOGICAL FIELD

The present disclosure relates to aerosol delivery devices such as smoking articles that may utilize electrically generated heat for the production of aerosol (e.g., smoking articles commonly referred to as electronic cigarettes), and more particularly to an application specific integrated circuit that provides a means for implementing a plurality of functions within an aerosol delivery device using a single integrated circuit. The smoking articles may be configured to heat an aerosol precursor, which may incorporate materials that may be made or derived from, or otherwise incorporate tobacco, the precursor being capable of forming an inhalable substance for human consumption.

### BACKGROUND

Many smoking devices have been proposed through the years as improvements upon, or alternatives to, smoking products that require combusting tobacco for use. Many of those devices purportedly have been designed to provide the sensations associated with cigarette, cigar or pipe smoking, but without delivering considerable quantities of incomplete combustion and pyrolysis products that result from the burning of tobacco. To this end, there have been proposed numerous smoking products, flavor generators and medicinal inhalers that utilize electrical energy to vaporize or heat a volatile material, or attempt to provide the sensations of cigarette, cigar or pipe smoking without burning tobacco to a significant degree. See, for example, the various alternative smoking articles, aerosol delivery devices and heat generating sources set forth in the background art described in U.S. Pat. Nos. 7,726,320 to Robinson et al. and U.S. Pat. No. 8,881,737 to Collett et al., which are incorporated herein by reference. See also, for example, the various types of smoking articles, aerosol delivery devices and electrically-powered heat generating sources referenced by brand name and commercial source in U.S. Pat. Pub. No. 2015/0216232 to Bless et al., which is incorporated herein by reference. Additionally, various types of electrically powered aerosol and vapor delivery devices also have been proposed in U.S. Pat. Pub. Nos. 2014/0096781 to Sears et al. and 2014/0283859 to Minskoff et al., as well as U.S. patent application Ser. Nos. 14/282,768 to Sears et al., filed May 20, 2014; Ser. No. 14/286,552 to Brinkley et al., filed May 23, 2014; Ser. No. 14/327,776 to Ampolini et al., filed Jul. 10, 2014; and Ser. No. 14/465,167 to Worm et al., filed Aug. 21, 2014; all of which are incorporated herein by reference.

Ongoing developments in the field of aerosol delivery devices have resulted in increasingly sophisticated aerosol delivery devices. For example, some aerosol delivery devices utilize integrated circuits to implement various discrete functions within the device. However, a single integrated circuit, as currently configured, may provide limited functionality, and thereby limited modulation of the aerosol delivery device. Therefore, a need exist for an application specific integrated circuit that provides a higher level of integration of functionality for an aerosol delivery device by executing various functions using a single integrated circuit, and thereby reduce manufacturing cost.

### BRIEF SUMMARY

The present disclosure relates to aerosol delivery devices, methods of forming such devices, and elements of such devices. The present disclosure thus includes, without limitation, the following example implementations. In some example implementations, an aerosol delivery device is provided that includes a housing, and a heating element and application specific integrated circuit (ASIC) contained within the housing. The heating element is configured to activate and vaporize components of the aerosol precursor composition in response to a flow of air through at least a portion of the housing, the air being combinable with a thereby formed vapor to form an aerosol. The ASIC may comprise system blocks designed to implement respective functions of the aerosol delivery device. The system blocks including at least a battery management block configured to manage a battery configured to power the aerosol delivery device, a flow sensor interface block configured to detect the flow of air through at least the portion of the housing, and an excitation block configured to cause activation of the heating element in response to an input from the flow sensor interface block that indicates the detection of the airflow through at least the portion of the housing.

In some example implementations of the aerosol delivery device of the preceding or any subsequent example implementation, or any combination thereof, the system blocks include at least one of a hardware non-programmable functional block or a programmable logic block.

In some example implementations of the aerosol delivery device of any preceding or any subsequent example implementation, or any combination thereof, the battery management block includes a control subsidiary block configured to direct power from the battery to the heating element in response to receiving an input from the flow sensor interface block that indicates the flow of air through at least the portion of the housing.

In some example implementations of the aerosol delivery device of any preceding or any subsequent example implementation, or any combination thereof, the aerosol delivery device further comprise a microprocessor, and the battery management block includes a light emitting diode (LED) driver subsidiary block configured to drive one or more LEDs based at least in part on input from one or more pulse width modulators being driven by the microprocessor.

In some example implementations of the aerosol delivery device of any preceding or any subsequent example implementation, or any combination thereof, the battery includes a rechargeable battery, and the battery management block includes a thermistor subsidiary block configured to prevent the battery from being overcharged in response to a detected increase in temperature of the battery.

In some example implementations of the aerosol delivery device of any preceding or any subsequent example implementation, or any combination thereof, the battery includes a rechargeable battery, and the battery management block includes a charging subsidiary block configured to control charging the battery at a constant current based at least in part on an input voltage, the charging subsidiary block being configured to exponentially decrease the constant current as the battery approaches a full charge.

In some example implementations of the aerosol delivery device of any preceding or any subsequent example implementation, or any combination thereof, the flow sensor interface block includes a sensor subsidiary block coupled to an external flow sensor, and configured to detect the flow of air through at least the portion of the housing based at least in part on input from the flow sensor.

In some example implementations of the aerosol delivery device of any preceding or any subsequent example implementation, or any combination thereof, the aerosol delivery device further comprises a microprocessor, and the flow sensor interface block further includes a regulator subsidiary block coupled to the sensor subsidiary block and configured to direct a regulated voltage to the microprocessor in response to receiving an input from the flow sensor that indicates the flow of air through the at least portion of the housing thereby disabling a transmission of power to the microprocessor and the heating element prior to the detection of the flow of air through the at least portion of the housing.

In some example implementations of the aerosol delivery device of any preceding or any subsequent example implementation, or any combination thereof, the flow sensor interface block further includes a power regulation subsidiary block coupled to the sensor subsidiary block and configured to in at least one instance, control the heating element.

In some example implementations of the aerosol delivery device of any preceding or any subsequent example implementation, or any combination thereof, the excitation block includes a linear vibrator motor driver subsidiary block configured to drive a vibrator motor in response to at least one of a detection of a low battery charge, or a detection of a low aerosol precursor composition quantity.

In some example implementations of the aerosol delivery device of any preceding or any subsequent example implementation, or any combination thereof, the excitation block includes a controlled power heater subsidiary block configured to receive an input voltage and direct power to the heating element to thereby cause activation of the heating element and control a power level of the heating element.

In some example implementations, a method for controlling operation of an aerosol delivery device including at least one housing containing a heating element and an application specific integrated circuit (ASIC) is provided. The method may include activating the heating element to vaporize components of an aerosol precursor composition in response to detection of flow of air through at least a portion of the housing, the air being combinable with a thereby formed vapor to form an aerosol, and controlling operation of the aerosol delivery device by the ASIC comprising system blocks designed to implement respective functions of the aerosol delivery device. The system blocks may include at least a battery management block managing a battery configured to power the aerosol delivery device, a flow sensor interface block detecting the flow of air through at least the portion of the housing, and an excitation block causing activation of the heating element in response to the detection of the airflow through at least the portion of the housing.

In some example implementations of the method of the preceding or any subsequent example implementation, or any combination thereof, the battery management block includes a control subsidiary block directing power from the battery to the heating element in response to receiving an input from the flow sensor interface block that indicates the flow of air through at least the portion of the housing.

In some example implementations of the method of any preceding or any subsequent example implementation, or any combination thereof, the aerosol delivery device further include a microprocessor, and the battery management block includes a light emitting diode (LED) driver subsidiary block driving one or more LEDs based at least in part on input from one or more pulse width modulators being driven by the microprocessor.

In some example implementations of the method of any preceding or any subsequent example implementation, or any combination thereof, the battery includes a rechargeable battery, and the battery management block includes a thermistor subsidiary block preventing the battery from being overcharged in response to a detected increase in temperature of the battery.

In some example implementations of the method of any preceding or any subsequent example implementation, or any combination thereof, the battery includes a rechargeable battery, and the battery management block includes a charging subsidiary block controlling charging the battery at a constant current based at least in part on a voltage input, the charging subsidiary block exponentially decreasing the constant current as the battery approaches a full charge.

In some example implementations of the method of any preceding or any subsequent example implementation, or any combination thereof, the flow sensor interface block includes a sensor subsidiary block coupled to an external flow sensor, and detecting the flow of air through at least the portion of the housing based at least in part on input from the flow sensor.

In some example implementations of the method of any preceding or any subsequent example implementation, or any combination thereof, the aerosol delivery device further comprises a microprocessor, and the flow sensor interface block further includes a regulator subsidiary block coupled to the sensor subsidiary block and directing a regulated voltage to the microprocessor in response to receiving an input from the flow sensor that indicates the flow of air through the at least portion of the housing thereby disabling a transmission of power to the microprocessor and the heating element prior to the detection of the flow of air through the at least portion of the housing.

In some example implementations of the method of any preceding or any subsequent example implementation, or any combination thereof, the flow sensor interface block further includes a power regulation subsidiary block coupled to the sensor subsidiary block and in at least one instance, controlling the heating element.

In some example implementations of the method of any preceding or any subsequent example implementation, or any combination thereof, the excitation block includes a linear vibrator motor driver subsidiary block driving a vibrator motor in response to at least one of a detection of a low battery charge, or a detection of a low aerosol precursor composition quantity.

In some example implementations of the method of any preceding or any subsequent example implementation, or any combination thereof, the excitation block includes a controlled power heater subsidiary block receiving an input voltage and directing power to the heating element to thereby cause activation of the heating element and control a power level of the heating element.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described the disclosure in the foregoing general terms, reference will now be made to the accompanying drawings, which are not necessarily drawn to scale, and wherein:

FIG. 1 illustrates a side view of an aerosol delivery device including a cartridge coupled to a control body according to an example implementation of the present disclosure;

FIG. 2 is a partially cut-away view of an aerosol delivery device that according to various example implementations may correspond to the aerosol delivery device of FIG. 1;

FIG. 3 illustrates an example configuration of various electronic components that may be within a suitable aerosol delivery device, according to example implementations;

FIG. 4 illustrates an application specific integrated circuit (ASIC) for use within an aerosol delivery device, according to example implementations of the present disclosure;

FIGS. 5-7 illustrate various system blocks of an ASIC such as the ASIC of FIG. 4, according to some example implementations;

FIG. 8 more particularly illustrates an ASIC for use within an aerosol delivery device, according to example implementations of the present disclosure; and

FIG. 9 illustrates various operations in a method of providing an aerosol delivery device, according to an example implementation of the present disclosure.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, the singular forms “a,” “an,” “the” and the like include plural referents unless the context clearly dictates otherwise.

As described hereinafter, example implementations of the present disclosure relate to aerosol delivery systems. Aerosol delivery systems according to the present disclosure use electrical energy to heat a material (preferably without combusting the material to any significant degree) to form an inhalable substance; and components of such systems have the form of articles most preferably are sufficiently compact to be considered hand-held devices. That is, use of components of preferred aerosol delivery systems does not result in the production of smoke in the sense that aerosol results principally from by-products of combustion or pyrolysis of tobacco, but rather, use of those preferred systems results in the production of vapors resulting from volatilization or vaporization of certain components incorporated therein. In some example implementations, components of aerosol delivery systems may be characterized as electronic cigarettes, and those electronic cigarettes most preferably incorporate tobacco and/or components derived from tobacco, and hence deliver tobacco derived components in aerosol form.

Aerosol generating pieces of certain preferred aerosol delivery systems may provide many of the sensations (e.g., inhalation and exhalation rituals, types of tastes or flavors, organoleptic effects, physical feel, use rituals, visual cues such as those provided by visible aerosol, and the like) of smoking a cigarette, cigar or pipe that is employed by lighting and burning tobacco (and hence inhaling tobacco smoke), without any substantial degree of combustion of any component thereof. For example, the user of an aerosol generating piece of the present disclosure can hold and use that piece much like a smoker employs a traditional type of smoking article, draw on one end of that piece for inhalation of aerosol produced by that piece, take or draw puffs at selected intervals of time, and the like.

Aerosol delivery systems of the present disclosure also can be characterized as being vapor-producing articles or medicament delivery articles. Thus, such articles or devices can be adapted so as to provide one or more substances (e.g., flavors and/or pharmaceutical active ingredients) in an inhalable form or state. For example, inhalable substances can be substantially in the form of a vapor (i.e., a substance that is in the gas phase at a temperature lower than its critical point). Alternatively, inhalable substances can be in the form of an aerosol (i.e., a suspension of fine solid particles or liquid droplets in a gas). For purposes of simplicity, the term “aerosol” as used herein is meant to include vapors, gases and aerosols of a form or type suitable for human inhalation, whether or not visible, and whether or not of a form that might be considered to be smoke-like.

Aerosol delivery systems of the present disclosure generally include a number of components provided within an outer body or shell, which may be referred to as a housing. The overall design of the outer body or shell can vary, and the format or configuration of the outer body that can define the overall size and shape of the aerosol delivery device can vary. Typically, an elongated body resembling the shape of a cigarette or cigar can be a formed from a single, unitary housing or the elongated housing can be formed of two or more separable bodies. For example, an aerosol delivery device can comprise an elongated shell or body that can be substantially tubular in shape and, as such, resemble the shape of a conventional cigarette or cigar. In one example, all of the components of the aerosol delivery device are contained within one housing. Alternatively, an aerosol delivery device can comprise two or more housings that are joined and are separable. For example, an aerosol delivery device can possess at one end a control body comprising a housing containing one or more reusable components (e.g., a rechargeable battery and various electronics for controlling the operation of that article), and at the other end and integral with or removably coupled thereto, an outer body or shell containing a disposable portion (e.g., a disposable flavor-containing cartridge).

Aerosol delivery systems of the present disclosure most preferably comprise some combination of a power source (i.e., an electrical power source), at least one control component (e.g., means for actuating, controlling, regulating and ceasing power for heat generation, such as by controlling electrical current flow the power source to other components of the article—e.g., a microprocessor, individually or as part of a microcontroller), a heater or heat generation member (e.g., an electrical resistance heating element or other component, which alone or in combination with one or more further elements may be commonly referred to as an “atomizer”), an aerosol precursor composition (e.g., commonly a liquid capable of yielding an aerosol upon application of sufficient heat, such as ingredients commonly referred to as “smoke juice,” “e-liquid” and “e-juice”), and a mouth end region or tip for allowing draw upon the aerosol delivery device for aerosol inhalation (e.g., a defined airflow path through the article such that aerosol generated can be withdrawn therefrom upon draw).

More specific formats, configurations and arrangements of components within the aerosol delivery systems of the present disclosure will be evident in light of the further disclosure provided hereinafter. Additionally, the selection and arrangement of various aerosol delivery system components can be appreciated upon consideration of the commercially available electronic aerosol delivery devices, such as those representative products referenced in background art section of the present disclosure.

In various examples, an aerosol delivery device can comprise a reservoir configured to retain the aerosol precursor composition. The reservoir particularly can be formed of a porous material (e.g., a fibrous material) and thus may be referred to as a porous substrate (e.g., a fibrous substrate).

A fibrous substrate useful as a reservoir in an aerosol delivery device can be a woven or nonwoven material formed of a plurality of fibers or filaments and can be formed of one or both of natural fibers and synthetic fibers. For example, a fibrous substrate may comprise a fiberglass material. In particular examples, a cellulose acetate material can be used. In other example implementations, a carbon material can be used. A reservoir may be substantially in the form of a container and may include a fibrous material included therein.

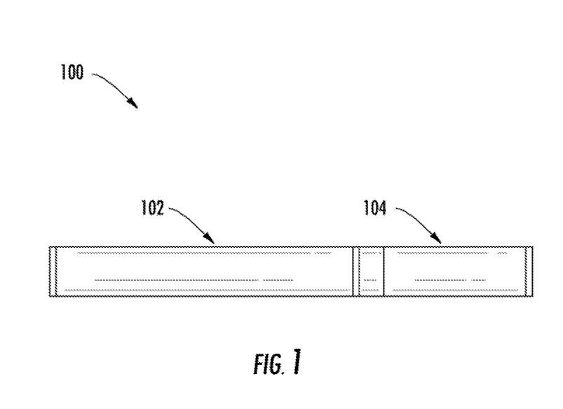

FIG. 1 illustrates a side view of an aerosol delivery device 100 including a control body 102 and a cartridge 104, according to various example implementations of the present disclosure. In particular, FIG. 1 illustrates the control body and the cartridge coupled to one another. The control body and the cartridge may be permanently or detachably aligned in a functioning relationship. Various mechanisms may connect the cartridge to the control body to result in a threaded engagement, a press-fit engagement, an interference fit, a magnetic engagement or the like. The aerosol delivery device may be substantially rod-like, substantially tubular shaped, or substantially cylindrically shaped in some example implementations when the cartridge and the control body are in an assembled configuration. The cartridge and control body may include a unitary housing or outer body or separate, respective housings or outer bodies, which may be formed of any of a number of different materials. The housing may be formed of any suitable, structurally-sound material. In some examples, the housing may be formed of a metal or alloy, such as stainless steel, aluminum or the like. Other suitable materials include various plastics (e.g., polycarbonate), metal-plating over plastic and the like.

In some example implementations, one or both of the control body 102 or the cartridge 104 of the aerosol delivery device 100 may be referred to as being disposable or as being reusable. For example, the control body may have a replaceable battery or a rechargeable battery and thus may be combined with any type of recharging technology, including connection to a typical alternating current electrical outlet, connection to a car charger (i.e., a cigarette lighter receptacle), and connection to a computer, such as through a universal serial bus (USB) cable or connector. Further, in some example implementations, the cartridge may comprise a single-use cartridge, as disclosed in U.S. Pat. No. 8,910,639 to Chang et al., which is incorporated herein by reference in its entirety.

In one example implementation, the control body 102 and cartridge 104 forming the aerosol delivery device 100 may be permanently coupled to one another. Examples of aerosol delivery devices that may be configured to be disposable and/or which may include first and second outer bodies that are configured for permanent coupling are disclosed in U.S. patent application Ser. No. 14/170,838 to Bless et al., filed Feb. 3, 2014, which is incorporated herein by reference in its entirety. In another example implementation, the cartridge and control body may be configured in a single-piece, non-detachable form and may incorporate the components, aspects, and features disclosed herein. However, in another example implementation, the control body and cartridge may be configured to be separable such that, for example, the cartridge may be refilled or replaced.

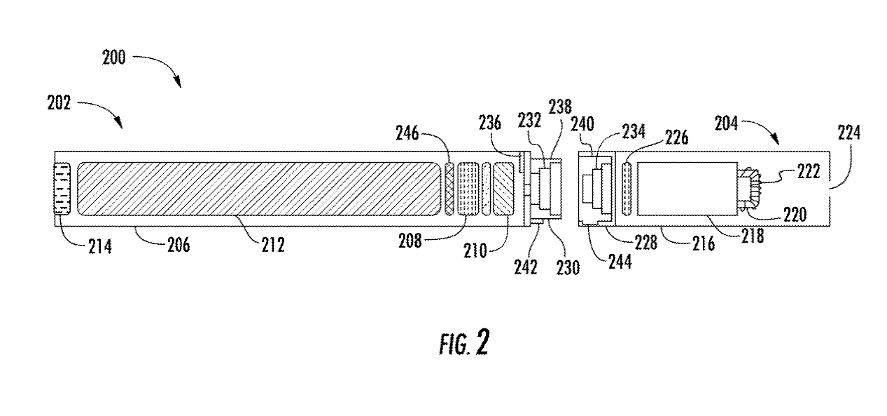

FIG. 2 illustrates a more particular example of a suitable aerosol delivery device 200 that in some examples may correspond to the aerosol delivery device 100 of FIG. 1. As seen in the cut-away view illustrated therein, the aerosol delivery device can comprise a control body 202 and a cartridge 204, which may correspond to respectively the control body 102 and cartridge 104 of FIG. 1. As illustrated in FIG. 2, the control body 202 can be formed of a control body shell 206 that can include a control component 208 (e.g., a microprocessor, individually or as part of a microcontroller), a flow sensor 210, a battery 212, and one or more light-emitting diodes (LEDs) 214, and such components may be variably aligned. Further indicators (e.g., a haptic feedback component, an audio feedback component, or the like) can be included in addition to or as an alternative to the LED. The cartridge 204 can be formed of a cartridge shell 216 enclosing a reservoir 218 that is in fluid communication with a liquid transport element 220 adapted to wick or otherwise transport an aerosol precursor composition stored in the reservoir housing to a heater 222 (sometimes referred to as a heating element). In some example, a valve may be positioned between the reservoir and heater, and configured to control an amount of aerosol precursor composition passed or delivered from the reservoir to the heater.

Various examples of materials configured to produce heat when electrical current is applied therethrough may be employed to form the heater 222. The heater in these examples may be resistive heating element such as a wire coil. Example materials from which the wire coil may be formed include Kanthal (FeCrAl), Nichrome, Molybdenum disilicide (MoSi₂), molybdenum silicide (MoSi), Molybdenum disilicide doped with Aluminum (Mo(Si,Al)₂), graphite and graphite-based materials (e.g., carbon-based foams and yarns) and ceramics (e.g., positive or negative temperature coefficient ceramics). Example implementations of heaters or heating members useful in aerosol delivery devices according to the present disclosure are further described below, and can be incorporated into devices such as illustrated in FIG. 2 as described herein.

An opening 224 may be present in the cartridge shell 216 (e.g., at the mouthend) to allow for egress of formed aerosol from the cartridge 204. Such components are representative of the components that may be present in a cartridge and are not intended to limit the scope of cartridge components that are encompassed by the present disclosure.

The cartridge 204 also may include one or more electronic components 226, which may include an integrated circuit, a memory component, a sensor, or the like. The electronic components may be adapted to communicate with the control component 208 and/or with an external device by wired or wireless means. The electronic components may be positioned anywhere within the cartridge or a base 228 thereof.

Although the control component 208 and the flow sensor 210 are illustrated separately, it is understood that the control component and the flow sensor may be combined as an electronic circuit board with the air flow sensor attached directly thereto. Further, the electronic circuit board may be positioned horizontally relative to the illustration of FIG. 1 in that the electronic circuit board can be lengthwise parallel to the central axis of the control body. In some examples, the air flow sensor may comprise its own circuit board or other base element to which it can be attached. In some examples, a flexible circuit board may be utilized. A flexible circuit board may be configured into a variety of shapes, include substantially tubular shapes. In some examples, a flexible circuit board may be combined with, layered onto, or form part or all of a heater substrate as further described below.

The control body 202 and the cartridge 204 may include components adapted to facilitate a fluid engagement therebetween. As illustrated in FIG. 2, the control body can include a coupler 230 having a cavity 232 therein. The base 228 of the cartridge can be adapted to engage the coupler and can include a projection 234 adapted to fit within the cavity. Such engagement can facilitate a stable connection between the control body and the cartridge as well as establish an electrical connection between the battery 212 and control component 208 in the control body and the heater 222 in the cartridge. Further, the control body shell 206 can include an air intake 236, which may be a notch in the shell where it connects to the coupler that allows for passage of ambient air around the coupler and into the shell where it then passes through the cavity 232 of the coupler and into the cartridge through the projection 234.

A coupler and a base useful according to the present disclosure are described in U.S. Pat. App. Pub. No. 2014/0261495 to Novak et al., which is incorporated herein by reference in its entirety. For example, the coupler 230 as seen in FIG. 2 may define an outer periphery 238 configured to mate with an inner periphery 240 of the base 228. In one example the inner periphery of the base may define a radius that is substantially equal to, or slightly greater than, a radius of the outer periphery of the coupler. Further, the coupler may define one or more protrusions 242 at the outer periphery configured to engage one or more recesses 244 defined at the inner periphery of the base. However, various other examples of structures, shapes and components may be employed to couple the base to the coupler. In some examples the connection between the base of the cartridge 204 and the coupler of the control body 202 may be substantially permanent, whereas in other examples the connection therebetween may be releasable such that, for example, the control body may be reused with one or more additional cartridges that may be disposable and/or refillable.

The aerosol delivery device 200 may be substantially rod-like or substantially tubular shaped or substantially cylindrically shaped in some examples. In other examples, further shapes and dimensions are encompassed—e.g., a rectangular or triangular cross-section, multifaceted shapes, or the like.

The reservoir 218 illustrated in FIG. 2 can be a container or can be a fibrous reservoir, as presently described. For example, the reservoir can comprise one or more layers of nonwoven fibers substantially formed into the shape of a tube encircling the interior of the cartridge shell 216, in this example. An aerosol precursor composition can be retained in the reservoir. Liquid components, for example, can be sorptively retained by the reservoir. The reservoir can be in fluid connection with the liquid transport element 220. The liquid transport element can transport the aerosol precursor composition stored in the reservoir via capillary action to the heater 222 that is in the form of a metal wire coil in this example. As such, the heater is in a heating arrangement with the liquid transport element. Example implementations of reservoirs and transport elements useful in aerosol delivery devices according to the present disclosure are further described below, and such reservoirs and/or transport elements can be incorporated into devices such as illustrated in FIG. 2 as described herein. In particular, specific combinations of heating members and transport elements as further described below may be incorporated into devices such as illustrated in FIG. 2 as described herein.

In use, when a user draws on the aerosol delivery device 200, airflow is detected by the flow sensor 210, and the heater 222 is activated to vaporize components of the aerosol precursor composition. Drawing upon the mouthend of the aerosol delivery device causes ambient air to enter the air intake 236 and pass through the cavity 232 in the coupler 230 and the central opening in the projection 234 of the base 228. In the cartridge 204, the drawn air combines with the formed vapor to form an aerosol. The aerosol is whisked, aspirated or otherwise drawn away from the heater and out the opening 224 in the mouthend of the aerosol delivery device.

In some examples, the aerosol delivery device 200 may include a number of additional software-controlled functions. For example, the aerosol delivery device may include a battery protection circuit configured to detect battery input, loads on the battery terminals, and charging input. The battery protection circuit may include short-circuit protection and under-voltage lock out. The aerosol delivery device may also include components for ambient temperature measurement, and its control component 208 may be configured to control at least one functional element to inhibit battery charging if the ambient temperature is below a certain temperature (e.g., 0° C.) or above a certain temperature (e.g., 45° C.) prior to start of charging or during charging.

Power delivery from the battery 212 may vary over the course of each puff on the device 200 according to a power control mechanism. The device may include a “long puff” safety timer such that in the event that a user or an inadvertent mechanism causes the device to attempt to puff continuously, the control component 208 may control at least one functional element to terminate the puff automatically after some period of time (e.g., four seconds). Further, the time between puffs on the device may be restricted to less than a period of time (e.g., 100). A watchdog safety timer may automatically reset the aerosol delivery device if its control component or software running on it becomes unstable and does not service the timer within an appropriate time interval (e.g., eight seconds). Further safety protection may be provided in the event of a defective or otherwise failed flow sensor 210, such as by permanently disabling the aerosol delivery device in order to prevent inadvertent heating. A puffing limit switch may deactivate the device in the event of a pressure sensor fail causing the device to continuously activate without stopping after the four second maximum puff time.

The aerosol delivery device 200 may include a puff tracking algorithm configured for heater lockout once a defined number of puffs has been achieved for an attached cartridge (based on the number of available puffs calculated in light of the e-liquid charge in the cartridge). In some implementations, the puff tracking algorithm indirectly counts the number of puffs based on a corresponding number of puff seconds (or milliseconds) in which the aerosol delivery device may track an elapsed duration of puff seconds. As such, the puff tracking algorithm may incrementally count a number of puff seconds in order to calculate when a specified number of puffs have occurred and subsequently shut off the device once the puff seconds reach what is estimated to be a pre-determined number of puffs. For example, a cartridge 204 may be pre-programmed with a puff second capacity, and upon tracking the puff seconds, the capacity may be decremented on a puff second basis. The puff tracking algorithm may further estimate the amount of e-liquid that is utilized per puff second, and mathematically calculate the e-liquid volume based at least in part on the estimation of corresponding puffs seconds. In some example implementations, a number of puffs may be recorded for later statistical usage and/or for tracking usage over a Bluetooth communication interface. For example, a corresponding Bluetooth application, in communication with the aerosol delivery device, may be configured to calculate average puff duration and present to the user a remaining number of puffs (based at least in part on the user-specific average puff duration)

The aerosol delivery device 200 may include a sleep, standby or low-power mode function whereby power delivery may be automatically cut off after a defined period of non-use. Further safety protection may be provided in that all charge/discharge cycles of the battery 212 may be monitored by the control component 208 over its lifetime. After the battery has attained the equivalent of a predetermined number (e.g., 200) full discharge and full recharge cycles, it may be declared depleted, and the control component may control at least one functional element to prevent further charging of the battery.

The various components of an aerosol delivery device according to the present disclosure can be chosen from components described in the art and commercially available. Examples of batteries that can be used according to the disclosure are described in U.S. Pat. App. Pub. No. 2010/0028766 to Peckerar et al., which is incorporated herein by reference in its entirety.

The aerosol delivery device 200 can incorporate the sensor 210 or another sensor or detector for control of supply of electric power to the heater 222 when aerosol generation is desired (e.g., upon draw during use). As such, for example, there is provided a manner or method of turning off the power supply to the heater when the aerosol delivery device is not be drawn upon during use, and for turning on the power supply to actuate or trigger the generation of heat by the heater during draw. Additional representative types of sensing or detection mechanisms, structure and configuration thereof, components thereof, and general methods of operation thereof, are described in U.S. Pat. No. 5,261,424 to Sprinkel, Jr., U.S. Pat. No. 5,372,148 to McCafferty et al., and PCT Pat. App. Pub. No. WO 2010/003480 to Flick, all of which are incorporated herein by reference in their entireties.

The aerosol delivery device 200 most preferably incorporates the control component 208 or another control mechanism for controlling the amount of electric power to the heater 222 during draw. Representative types of electronic components, structure and configuration thereof, features thereof, and general methods of operation thereof, are described in U.S. Pat. No. 4,735,217 to Gerth et al., U.S. Pat. No. 4,947,874 to Brooks et al., U.S. Pat. No. 5,372,148 to McCafferty et al., U.S. Pat. No. 6,040,560 to Fleischhauer et al., U.S. Pat. No. 7,040,314 to Nguyen et al., U.S. Pat. No. 8,205,622 to Pan, U.S. Pat. App. Pub. No. 2009/0230117 to Fernando et al., U.S. Pat. App. Pub. No. 2014/0060554 to Collet et al., U.S. Pat. App. Pub. No. 2014/0270727 to Ampolini et al., and U.S. patent application Ser. No. 14/209,191 to Henry et al., filed Mar. 13, 2014, all of which are incorporated herein by reference in their entireties.

Representative types of substrates, reservoirs or other components for supporting the aerosol precursor are described in U.S. Pat. No. 8,528,569 to Newton, U.S. Pat. App. Pub. No. 2014/0261487 to Chapman et al., U.S. patent application Ser. No. 14/011,992 to Davis et al., filed Aug. 28, 2013, and U.S. patetn application Ser. No. 14/170,838 to Bless et al., filed Feb. 3, 2014, all of which are incorporated herein by reference in their entireties. Additionally, various wicking materials, and the configuration and operation of those wicking materials within certain types of electronic cigarettes, are set forth in U.S. Pat. App. Pub. No. 2014/0209105 to Sears et al., which is incorporated herein by reference in its entirety.

The aerosol precursor composition, also referred to as a vapor precursor composition, may comprise a variety of components including, by way of example, a polyhydric alcohol (e.g., glycerin, propylene glycol or a mixture thereof), nicotine, tobacco, tobacco extract and/or flavorants. Representative types of aerosol precursor components and formulations also are set forth and characterized in U.S. Pat. No. 7,217,320 to Robinson et al. and U.S. Pat. Pub. Nos. 2013/0008457 to Zheng et al.; 2013/0213417 to Chong et al.; 2014/0060554 to Collett et al.; 2015/0020823 to Lipowicz et al.; and 2015/0020830 to Koller, as well as WO 2014/182736 to Bowen et al, the disclosures of which are incorporated herein by reference. Other aerosol precursors that may be employed include the aerosol precursors that have been incorporated in the VUSE® product by R. J. Reynolds Vapor Company, the BLU™ product by Lorillard Technologies, the MISTIC MENTHOL product by Mistic Ecigs, and the VYPE product by CN Creative Ltd. Also desirable are the so-called “smoke juices” for electronic cigarettes that have been available from Johnson Creek Enterprises LLC.

Additional representative types of components that yield visual cues or indicators may be employed in the aerosol delivery device 200, such as LEDs and related components, auditory elements (e.g., speakers), vibratory elements (e.g., vibration motors) and the like. Examples of suitable LED components, and the configurations and uses thereof, are described in U.S. Pat. No. 5,154,192 to Sprinkel et al., U.S. Pat. No. 8,499,766 to Newton, U.S. Pat. No. 8,539,959 to Scatterday, and U.S. patent application Ser. No. 14/173,266 to Sears et al., filed Feb. 5, 2014, all of which are incorporated herein by reference in their entireties.

Yet other features, controls or components that can be incorporated into aerosol delivery devices of the present disclosure are described in U.S. Pat. No. 5,967,148 to Harris et al., U.S. Pat. No. 5,934,289 to Watkins et al., U.S. Pat. No. 5,954,979 to Counts et al., U.S. Pat. No. 6,040,560 to Fleischhauer et al., U.S. Pat. No. 8,365,742 to Hon, U.S. Pat. No. 8,402,976 to Fernando et al., U.S. Pat. App. Pub. No. 2005/0016550 to Katase, U.S. Pat. App. Pub. No. 2010/0163063 to Fernando et al., U.S. Pat. App. Pub. No. 2013/0192623 to Tucker et al., U.S. Pat. App. Pub. No. 2013/0298905 to Leven et al., U.S. Pat. App. Pub. No. 2013/0180553 to Kim et al., U.S. Pat. App. Pub. No. 2014/0000638 to Sebastian et al., U.S. Pat. App. Pub. No. 2014/0261495 to Novak et al., and U.S. Pat. App. Pub. No. 2014/0261408 to DePiano et al., all of which are incorporated herein by reference in their entireties.

The control component 208 includes a number of electronic components, and in some examples may be formed of a printed circuit board (PCB) that supports and electrically connects the electronic components. Examples of suitable electronic components include a microprocessor or processor core, an application specific integrated circuit (ASIC), a memory, and the like. In some examples, the control component may include a microcontroller with an integrated processor core and memory, and which may further include one or more integrated input/output peripherals.

The aerosol delivery device 200 may further include a communication interface 246 coupled to the control component 208, and which may be configured to enable wireless communication. In some examples, the communication interface may be included on the PCB of the control component, or a separate PCB that may be coupled to the PCB or one or more components of the control component. The communication interface may enable the aerosol delivery device to wirelessly communicate with one or more networks, computing devices or other appropriately-enabled devices. Examples of suitable computing devices include any of a number of different mobile computers. More particular examples of suitable mobile computers include portable computers (e.g., laptops, notebooks, tablet computers), mobile phones (e.g., cell phones, smartphones), wearable computers (e.g., smartwatches) and the like. In other examples, the computing device may be embodied as other than a mobile computer, such as in the manner of a desktop computer, server computer or the like. And in yet another example, the computing device may be embodied as an electric beacon such as one employing iBeacon™ technology developed by Apple Inc. Examples of suitable manners according to which the aerosol delivery device may be configured to wirelessly communicate are disclosed in U.S. patent application Ser. No. 14/327,776, filed Jul. 10, 2014, to Ampolini et al., and U.S. patent application Ser. No. 14/609,032, filed Jan. 29, 2015, to Henry, Jr. et al., each of which is incorporated herein by reference in its entirety.

The communication interface 246 may include, for example, an antenna (or multiple antennas) and supporting hardware and/or software for enabling wireless communication with a communication network (e.g., a cellular network, Wi-Fi, WLAN, and/or the like), and/or for supporting device-to-device, short-range communication, in accordance with a desired communication technology. Examples of suitable short-range communication technologies that may be supported by the communication interface include various near field communication (NFC) technologies, wireless personal area network (WPAN) technologies and the like. More particular examples of suitable WPAN technologies include those specified by IEEE 802.15 standards or otherwise, including Bluetooth, Bluetooth low energy (Bluetooth LE), ZigBee, infrared (e.g., IrDA), radio-frequency identification (RFID), Wireless USB and the like. Yet other examples of suitable short-range communication technologies include Wi-Fi Direct, as well as certain other technologies based on or specified by IEEE 802.11 standards and that support direct device-to-device communication.

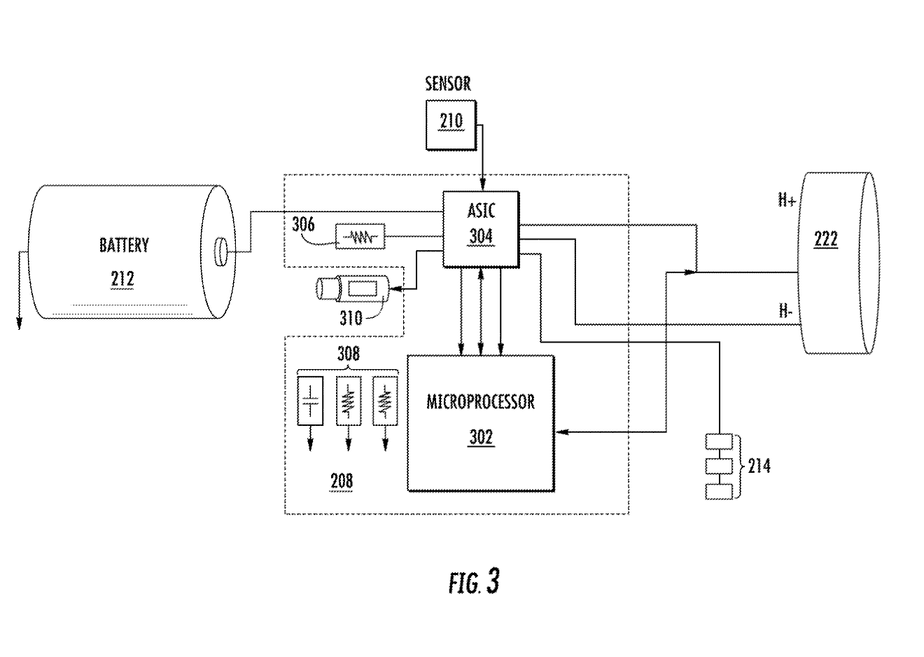

To further illustrate aspects of example implementations of the present disclosure, reference is now made to FIGS. 3-9 which illustrate various electronic components for use within a suitable aerosol delivery device.

FIG. 3 illustrates various ones of the components of the aerosol delivery device 200 of FIG. 2, more particularly illustrating the control component 208 according to some example implementations of the present disclosure. As shown, the control component may include a microprocessor 302, an ASIC 304 or other integrated circuit, a thermistor 306, and one or more supplemental electrical components 308 (e.g. a memory component, a transducer/sensor, a diode, a transistor, an optoelectronic device, a resistor, a capacitor, a switch, and the like) in which such components can be variably aligned. As suggested above, the control component may be coupled to other components of the aerosol delivery device, such as the flow sensor 210, battery 212, LEDs 214, and heater 222. The control component may also be coupled to one or more other components external to the control component not specifically illustrated in FIG. 2, such as a vibrator motor 310.

It should be noted that, although some instances of the example implementations explicitly illustrate a one-directional (e.g. receiving or sending) and/or two-directional connection between two components, any electrical connections illustrated and discussed herein may refer to either a one-direction connection configured to receive electronic signals, a one-directional connection configured to send electronic signals, or a two-directional connection configured both send and/or receive electronic signals.

In accordance with example implementations of the present disclosure, the ASIC 304 may be designed to maximize safety and performance of the aerosol delivery device 200 by integrating a plurality of critical functions within a single circuit that enables full control and optimization of the aerosol delivery device. As such, the ASIC may be operatively coupled to the microprocessor 302, thermistor 306, vibrator motor 310, sensor 210 (e.g. pressure sensor), battery 212, LEDs 214, and heater 222. The ASIC may facilitate one or more functions such as providing power to a microprocessor, awaking the microprocessor from an inactive state, providing electrical communication between various components of the aerosol delivery device, and the like. In one example implementation, at least three 20 mA LED drivers may be provided in order to support microcontrollers with limited pin drives. Furthermore, the ASIC may comprise a vibrator drive pin capable of handling 150 mA thereby enabling support of the vibrator 310. The ASIC may be further configured to provide a level of authentication and encryption on all digital links between the ASIC and the microprocessor. The heater may be operatively connected to both the ASIC 304 and the microprocessor 302.

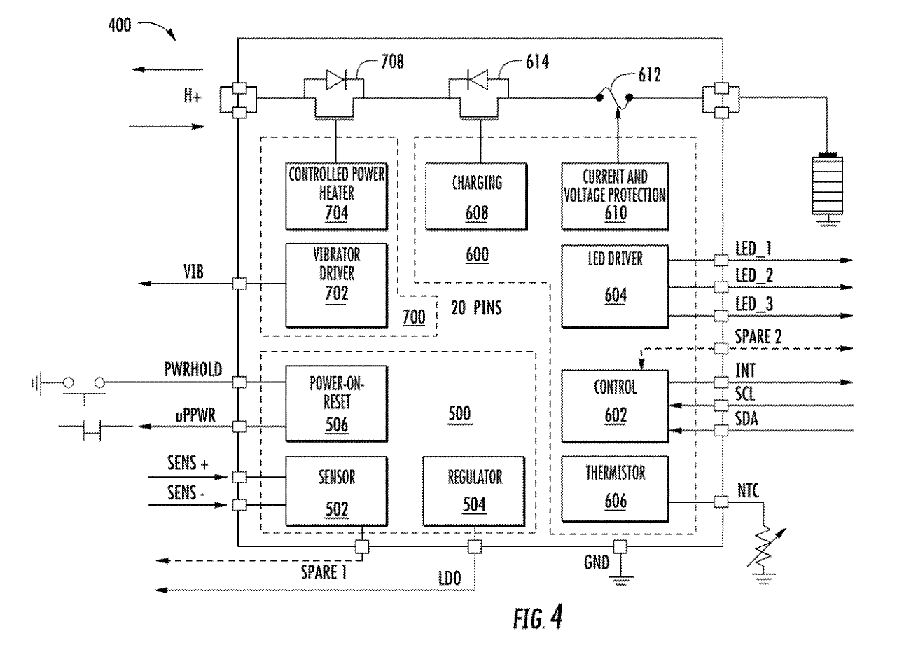

FIG. 4 illustrates an ASIC 400 that may be one example of the ASIC 304 of FIG. 3. The ASIC may comprise system blocks designed to implement respective functions of an aerosol delivery device 100, 200. The system blocks may be composed of subsidiary blocks. For example, as illustrated, one or more of the subsidiary blocks, depicted in the example implementation of FIG. 4, may collectively form a system block (e.g. flow sensor interface block 500, battery management block 600, and excitation block 700) configured to perform various functions disclosed herein. It should be noted that, in some example implementations, the grouping of the one or more of the subsidiary blocks may be altered to implement alternative configurations of the system blocks.

The system blocks may include at least one of a flow sensor interface block 500 configured to detect the flow of air through at least the portion of the housing, a battery management block, a battery management block configured to manage a battery configured to power the aerosol delivery device 600 configured to manage a battery configured to power the aerosol delivery device, and an excitation block 700 configured to cause activation of the heater in response to an input from the flow sensor interface block that indicates the detection of the airflow through at least the portion of the housing. In some example implementations, the system blocks may be or include a plurality of hardware non-programmable functional blocks and/or programmable logic blocks, which may collectively be referred to as “blocks” hereinafter.

As shown, the flow sensor interface block 500, battery management block 600, and excitation block 700 may each comprise one or more subsidiary blocks in which the subsidiary blocks and related components may be variably aligned. The subsidiary blocks of the flow sensor interface block may include a sensor block 502, regulator subsidiary block 504, and power-on-reset subsidiary block 506. The subsidiary blocks of the battery management block may include a control block 602, LED driver block 604, thermistor block 606, charging block 608, and current and voltage protection block 610. The subsidiary blocks of the excitation block may include a vibrator motor driver block 702 and controlled power heater block 704.

The blocks may also be coupled to one or more optional electronic components such as a core safety protection 612 or transistors 614, 708. The core safety protection may be integrated within the ASIC 400 such that the ASIC may protect the battery from being overcharged, over-discharged (voltage), and/or from excessive current. In one example implementation, the transistors may be 70 milliohm field effect transistors (FETs)” that may be function as solid state switches configured to turn off voltage to the heater (when puffing) or to the battery (when charging). In some example implementations, the FETs may be integrated with the current and voltage protection block 610 to minimize the series resistance of the ASIC.

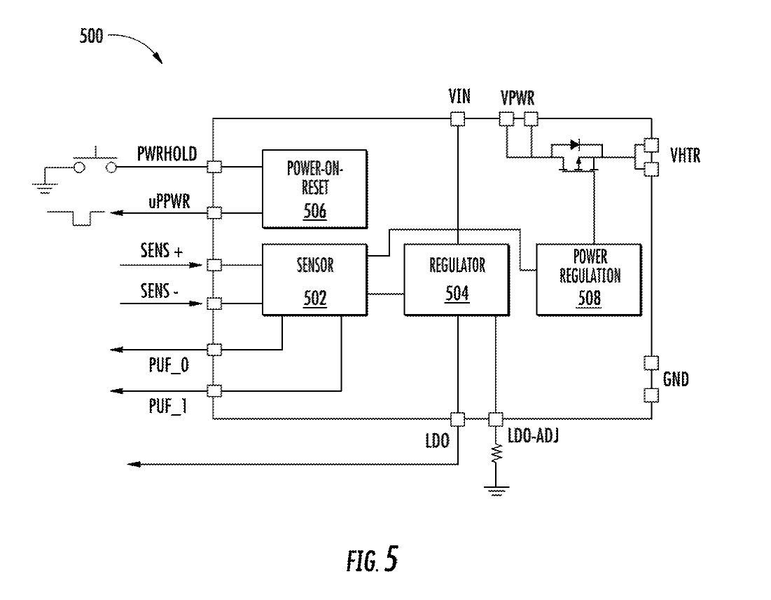

FIG. 5 illustrates a more particular example of the flow sensor system block 500 of FIG. 4. As suggested above, the flow sensor system block may include a sensor subsidiary block 502, a regulator subsidiary block 504, and a power-on-reset subsidiary block 506. As shown, the flow sensor interface block may also include a power regulation subsidiary block 508 in which the subsidiary blocks and related components of the flow sensor system block may be variably aligned.

The sensor subsidiary block 502 may be configured to detect the flow of air through at least the portion of the housing based at least in part on input from an external flow sensor. As such, the sensor subsidiary block may include sense circuitry for driving and detecting user activity (e.g., puffing) on the aerosol delivery device. For example, the sensor subsidiary block may be or include an electret microphone or bend sensor. In alternative implementations, the sensor subsidiary block may be or include other sensors such as micro-electro-mechanical systems (MEMS) sensors and/or resistive or piezo-electric bend sensors.

The sensor subsidiary block 502 may receive an input from an external sensor and configured to detect the flow of air through at least the portion of the housing based at least in part on input from the external sensor. The sensor subsidiary block may then provide a signal output (PUF) to the microprocessor (e.g., microprocessor 302) thereby indicating the detection of a puff. In some example implementations, the sensor subsidiary block may sense a puff event and interrupt the microprocessor. The sensor subsidiary block may also be configured to measure puff intensity and relay the measured data to the microprocessor or controlled power heater block 704. As such, referring back to FIG. 4, the sensor subsidiary block may provide an output to the microprocessor in addition to other devices such as LEDs, vibrators, programmable logic block, spare pins, and the like. The sensor subsidiary block 502 may additionally be coupled to the regulator block 572 and the power regulation block 574 to indicate the detection of puffs for implementing additional functionality.

The regulator subsidiary block 504 may be configured to direct a regulated voltage to the microprocessor, and any other components that may be powered off, in response to receiving an input from a flow sensor that indicates the flow of air through the at least portion of the housing. In one example implementations, if the regulator block is powered off in an instance in which puffs are not detected, the microprocessor (e.g., microprocessor 302) and/or other programmable logic blocks may be completely powered off to maximize a corresponding shelf life of the aerosol delivery device. The regulator subsidiary block may be or include a voltage regulator configured to provide an output to the microprocessor. In one example, the microprocessor may be completely powered off and isolated from the battery by the regulator. In one example implementation, the voltage regulator may be or include a low-dropout (LDO) voltage or linear regulator that may require a minimum voltage difference between the input and output for operation. The regulator subsidiary block may receive a voltage input from the battery and provide an output to the microprocessor or any other external components which are low current and thereby able to be powered off during shelving of the aerosol delivery device. As such, the regulator subsidiary block may function as a power supply for the microprocessor and various other components thereby converting the voltage from the battery (e.g., 3-4.2V) to a lower voltage (e.g., 1.8V).

In one example implementation, the voltage regulator may default to 3.0V and 50 mA, and may be programmable with an external resistor in which the external resistor may be configured to vary the voltage within a range of 1.5V to 3.3V. In other example implementations, the voltage regulator may be programmed to operate within a range of 1.1V to 3.3V with respect to increments of 100 mV. The regulator subsidiary block 504 may additionally be connected to a ground terminal via a resistor such that the voltage regulator is configured to adjust voltages within the ASIC 500, and more particularly adjust the output of the voltage regulator.

The power-on-reset subsidiary block 506 may be configured to reset power to a control component within the control subsidiary block 602 which may be or include a microprocessor of the ASIC 400. For example, power-on-reset subsidiary block may be configured to implement basic logic for facilitating a power on button and resetting the microprocessor. In one example implementation, the power-on-reset subsidiary block may be operatively coupled to the control component power supply and a ground terminal via a push button such that the power-on-reset block may be configured to short circuit power to the control component in response to the push button being engaged. In one example implementation, the power-on-reset subsidiary block may be coupled to the control component power supply via an open drain.

For example, a signal input (PWRHOLD) may be utilized by the microprocessor or an external switch to enable power to the microprocessor. In one example implementation, the signal input may be utilized by the microprocessor to ensure the regulator within the regulator subsidiary block 504 remains powered on after a detected puff has ended. Alternatively, the power-on-rest subsidiary block 506 may further provide a signal (uPPWR) to control the microprocessor power in instances in which the internal the regulator subsidiary block is not implemented.

The sensor subsidiary block 502 may be configured to control the heater via the power regulation block 508, in which the power regulation block may receive an input from the microprocessor to limit and/or gate heating. The power regulation block may be configured to implement additional functionality such as time outs or voltage boosts to thereby ensure the switch (e.g., FET) is driven optimally and a suitable and non-excessive duration. The power regulation block may be generally configured to function as a switch driver for the heater and thereby implement any electronics and/or logic to maximize efficiency of the switch (e.g., safety timeouts, and the like).

The power regulation block 508 may be coupled to a voltage power source for the heater, and a heater via a 35mOhms pass MOSFET. In some implementations, the power regulation block may function as a heater control block and regulate the power to the heater via the FET. In particular, the voltage power source may be coupled to the drain terminal of the MOSFET, the input heater may be coupled to the source terminal of the MOSFET, and the gate of the MOSFET may be directly connected to the power regulation subsidiary block. In one example implementation, the voltage power source may be the battery voltage after the over current-over/under voltage safety device.

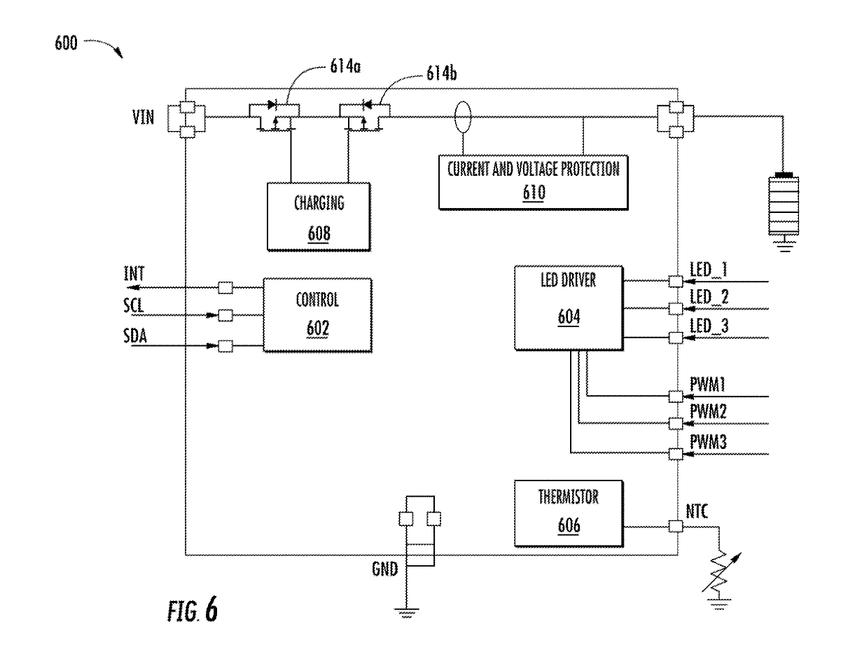

FIG. 6 illustrates a more particular example of the battery management system block 600 of FIG. 4. As suggested above, the battery management system block may include a control subsidiary block 602, an LED driver subsidiary block 604, a thermistor subsidiary block 606, a charging subsidiary block 608, and a current monitoring and voltage protection subsidiary block 610 in which the subsidiary blocks and related components of the battery management system block may be variably aligned.

The control subsidiary block 602 may be generally configured to direct power from a battery to the heater in response to receiving an input from the flow sensor system block 500 that indicates the flow of air through at least the portion of the housing. The control subsidiary block may function as a control interface that in some examples may be, or include a control component 208 (e.g., a microprocessor). Through the control subsidiary block, the ASIC 400 may exchange messages, commands, data, and the like (e.g., required power level of the heater, required LED pattern for display, intensity at which the user is pulling on the aerosol delivery device) with one or more components of the control component 208 such as the microprocessor (e.g., microprocessor 302).

In particular, the control subsidiary block 602 may receive an input from the microprocessor 302, or one or more spare pins, and direct an output to the microprocessor and the one or more spare pins. As such, the control subsidiary block may implement various functions such as controlling the transmission of power to the heater, in additional to controlling other hardware components within the ASIC 400 or the aerosol delivery device 100, 200. In one example implementation, the control subsidiary block 602 may receive an input from a serial communications bus of the microprocessor known as I2C—Serial Clock (SCL) and Serial Data (SDA).

The LED driver subsidiary block 604 may be configured to drive an LED based at least in part on input from one or more pulse width modulators (PWMs) being driven by the microprocessor (e.g., microprocessor 302). The LEDs may be powered during and/or after puffs to indicate low battery or cartridge capacity. In one example implementation, the LED driver block may be or include a 20 mA LED driver. The LED driver subsidiary block may provide an output signal to one or more LEDs and additionally receive an input signal from one or more pulse width modulators. In one example implementation, the pulse width modulators may be configured to provide a square signal input that drives a selection of whether or not the LEDs are on/off. As such, the LEDs may operate with respect to a consistent current.

In some example implementations, low current pulse width modulation lines from the control component 208, and more particularly the microprocessor (e.g., microprocessor 302), may control the duty cycle of the LEDs, in which the control component may be configured to provide sufficient current to drive the LEDs. In one implementation, for example, the LED driver subsidiary block 604 may reduce complexity of the microprocessor by controlling the LEDs via the same serial bus thereby freeing general purpose input/output pins on the microprocessor for other applications and leading to an overall cost savings. LED drivers incorporated into the ASIC 400 may be optimized to provide better control of the LEDs and incorporate additional features within the LEDs, such as dimming or specific flash patterns.

The thermistor subsidiary block 606 may be configured to prevent the battery from being overcharged in response to a detected increase in temperature of the battery. In one example implementation, the thermistor block may be or include a negative temperature coefficient thermistor (NTC) that is connected to ground via a variable resistor configured to measure temperature within the ASIC 400. The NTC may be a specific sensor type utilizing for sensing temperature. The thermistor subsidiary block 606 may be configured to monitor the ambient temperature within the aerosol delivery device, or more particularly within the battery, and disable charging and discharging outside of the standard temperature limits. In some example implementations, the standard temperature range may be determined according to the Japanese standard for temperature ranges (e.g., JEITA).

The charging subsidiary block 608 may be configured to control charging a battery at a constant current based at least in part on a voltage input. The charging subsidiary block may be configured to exponentially decrease the constant current as the battery approaches a full charge. In one example implementation, the charging block may be or include a 100 mA to 500 mA constant-current constant-voltage (CC/CV) charger that receives an input from a voltage source (e.g., external charging component) via a pass MOSFET. The MOSFETs may prevent the backflow of current within the circuit. In another example implementation, the charging subsidiary block may be or include a 300 mA CC/CV charger that receives an input from a battery via a pass metal-oxide semiconductor field-effect transistor (MOSFET).

The current and voltage protection subsidiary block 610 may be configured to manage over-current, over-voltage, and under-voltage scenarios. In one example implementation, the current and voltage protection block may prevent charging if the device temperature is less than 0° C. or greater than 45° C. The current and voltage protection subsidiary block 610 may be configured to disconnect the battery 212 upon detection of excessive voltage or currents, and/or disconnect the battery in response to the battery being discharged below a minimum voltage. The charging subsidiary block 608 may provide an output to the battery in which the output to the battery passes through the current monitoring and voltage protection block prior to being directed to the battery.

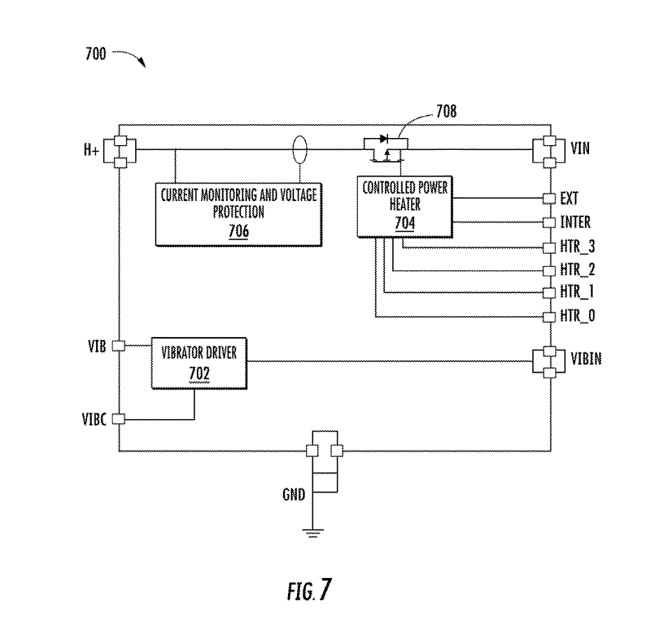

FIG. 7 illustrates a more particular example of the excitation system block 700 of FIG. 4. As suggested above, the excitation system block may include a vibrator motor driver subsidiary block 702 and a controlled power heater subsidiary block 704. As shown, the excitation system block may also include a current monitoring and voltage protection subsidiary block 706 in which the subsidiary blocks and related components of the battery management system block may be variably aligned.

The vibrator driver subsidiary block 702 may be configured to drive a vibrator motor in response to at least one of a detection of a low battery charge, a detection of a low aerosol precursor composition quantity. In one example implementation, the vibrator driver subsidiary block may be or include a 150 mA linear vibrator motor driver configured to drive a vibrator that is externally connected to the ASIC 400. The vibrator driver block 750 may additionally receive an input (VIBC) from the microprocessor (e.g., microprocessor 302) indicating when the vibrator should be driven. The vibrator driver subsidiary block may provide a signal (VIB) to turn on a corresponding vibrator, in which the signal may be either a positive voltage output to the vibrator or a switchable current sink.

In some example implementations, the vibrator driver subsidiary block 702 may be optionally provided. For example, in instances in which the aerosol delivery device may include a vibrator motor for providing haptic feedback, the vibrator driver subsidiary block may implemented within the ASIC and controllable over a digital interface thereby eliminating the need for a discrete transistor (e.g., FET) and further freeing one or more general input/output pins as the corresponding vibrator may be switched on/off via commands on a serial bus (e.g., serial bus from a microprocessor associated with the control subsidiary block 602).

The controlled power heater subsidiary block 704 may be configured to receive a voltage input and direct power to the heater to thereby cause activation of the heater in which different heater power levels may be signaled via various signal inputs. In one example implementation, the controlled power heater subsidiary block may receive a voltage input and provide an output to the heater via a 24mOhm pass MOSFET in which the heater may be connected to the drain of the MOSFET, the voltage input may be connected to the source of the MOSFET.

The controlled power heater subsidiary block 704 may be configured to measure and modulate the current during heating to ensure the desired power is always delivered to the heater thereby reducing the complexity of the microprocessor (e.g., microprocessor 302). In some example implementations, the FETs may be used to sense current and therefore eliminate the need of a separate and distinct current sense resistor. For example, the controlled power heater subsidiary block may sense the current in the MOSFET and modulate a switch to deliver the desired current.

In another example implementation, the controlled power heater subsidiary block 704 may provide an output to the heater via a 70 mOhm pass MOSFET. The output of the controlled power heater subsidiary block may additionally pass through the current monitoring and voltage protection block 706 prior to being transmitted to the heater. The controlled power heater subsidiary block may additionally provide a signal to interface to an external FET or similar device (EXT), receive an interrupt signal from the microprocessor indicating a desired interruption of heating (INTER), and a plurality of other signals from the microprocessor, or other programmable logic blocks indicating a desired heating level (HTR). The interrupt signal may be configured to interrupt the microprocessor (e.g., microprocessor 302) and/or awaken the microprocessor from an idle or dormant mode (e.g., sleep mode) upon detection of a puff, attachment of a charger, or another user initiated function.

In some implementations, circuits corresponding to the battery management system block 600 and the excitation block 700 may be integrated to form a power management system block. To this extent, the ASIC may be configured to provide extensive power control such that flexibility is provided with respect to the overall operation of the aerosol delivery device.

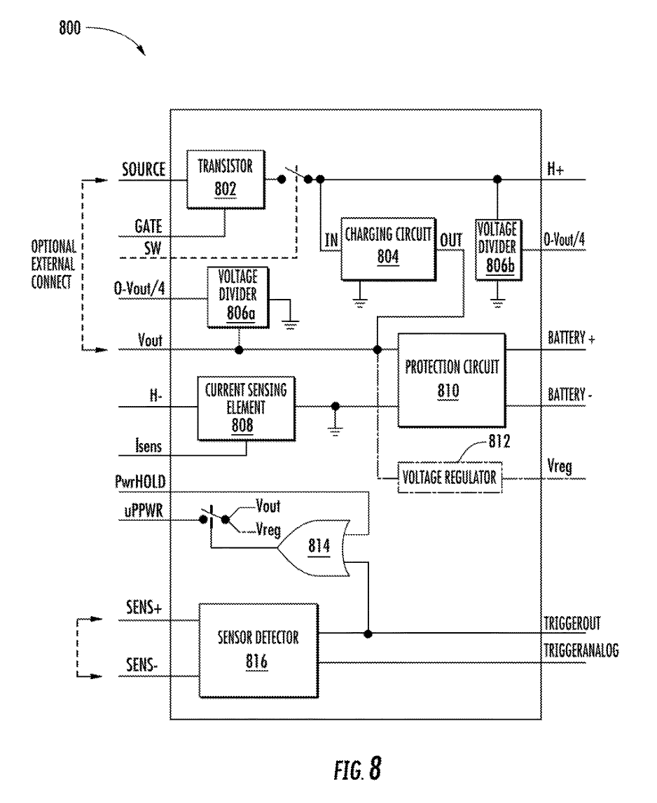

FIG. 8 illustrates a more particular example of a suitable ASIC 800 that may be one example of ASIC 304 of FIG. 3 and the ASIC 400 of FIG. 4. The ASIC may include a plurality of electronic components including a transistor 802 (e.g., a field-effect transistor (FET), a thyristor, a composite transistor, and the like), a charging circuit 804 (e.g. regenerative alkaline charging circuit, lithium polymer charging circuit, low-loss charging circuit, lithium-ion charging circuit, and/or another charging circuit not explicitly contemplated herein), one or more voltage dividers 806, a current sensing element 808, a protection circuit 810 (e.g. a lithium ion protection circuit with ambient temperature protection), a voltage regulator 812, a logical gate 814, and a sensor detector 816 in which such components may be variably aligned.

The transistor 802 may be configured to enable and/or disable voltage transmission to the heater and battery. In one example implementation, the transistor may be a P-MOSFET transistor. The transistor may be optionally coupled one or more externally connected sources (e.g. source, gate, SW) such that that transistor may be enabled to control heating, charging and/or interrupt the battery in instances of over/under voltage or over current. For example, a terminal of the transistor may be operatively coupled to, or otherwise configured to receive an input from a battery voltage source. The transistor may also be coupled to a positive terminal of the heater. In particular, the positive terminal of the heater may be operatively coupled to the transistor via a switch. In one example implementation, the characteristic of the switch may be less than 50 milliohms resistance in saturation (Rds), a peak current of greater than 2 Amps, and a gate to source voltage of less than −0.9 Volts.

The charging circuit 804 may be one example of the charging subsidiary block 608 of FIGS. 4 and 5. In one example implementation, the charging circuit may be or include a lithium ion charging circuit that receives an input from the heater and provides an output to the battery. The charging circuit may also be coupled to a ground terminal.

The one or more voltage dividers 806 may include a first and a second voltage divider 806a, 806b, respectively. The voltage divider may be generally configured adapt the battery voltage and/or the voltage at the heater to be compatible with standard analog-to-digital converters. The first voltage divider may an input from a voltage source (Vₒᵤₜ) and may be coupled to a ground terminal such that the voltage divider outputs a voltage ranging from 0−Vₒᵤₜ/4 Volts. The second voltage divider may receive an input from the positive terminal of the heater and may be coupled to a ground terminal such that the voltage divider outputs a voltage ranging from 0−Vₒᵤₜ/4 Volts. The second voltage divider may be provided in instances in which the battery voltage is four times the capacity of the analog to digital converter within the microprocessor 302.

The current sensing element 808 may receive an input from the heater and may be coupled to a ground terminal such that the current sensing element provides an output (lsens) to a microprocessor (e.g., microprocessor 302) externally connected to the ASIC 800 in which the output may be an analog signal proportional to the current in the heater. In such an implementation, the output may range from 0−Vₒᵤₜ Volts per −2 to 2 Amp with 2 percent (2%) accuracy. As such, control and limiting of power to the heater may be directly managed using the pass elements as current sense elements, thereby altering the convention process by eliminating the need for an external precision current sense resistor.

The protection circuit 810 may be one example of the current monitoring and voltage protection subsidiary block 610 of FIGS. 4 and 6. In one example implementation, the protection circuit may be or include a lithium ion protection circuit with ambient temperature protection. The protection circuit may receive an input from a voltage source in which the voltage source corresponds to the voltage source of the first voltage divider 806a. The protection circuit additionally receives an input from a current source in which the current source corresponds to the output of the charging circuit 804. The protection circuit may be further coupled a ground terminal and provide an output to the battery. The protection circuit, and more specifically the input terminal of the protection circuit, may be coupled to a voltage regulator 812. In one implementation, the voltage regulator is a 1.8 Volts voltage regulator. The voltage regulator 812 may be one example of the regulator subsidiary block 504 of FIGS. 4 and 5.

The logical gate 814 may be one example of the power-on-reset subsidiary block 506 of FIGS. 4 and 5. In one example implementation, the logical gate may be or include an OR gate configured to facilitate a power reset function within the ASIC 800. In some implementations, the logical gate may be provided in alternative to a voltage regulator (e.g., LDO regulator). The logical gate may be configured to receive an input from the microprocessor (power hold) and the first trigger output of the sensor detector 816. The logical gate output may be coupled to the drain of a switch. The first end of the switch may connected to the voltage source (Vₒᵤₜ)and the voltage regulator, and the second end of the switch may be coupled to the power source of the microprocessor such that in response to the switch closing the power of the microprocessor is reset.

The sensor detector 816 may be one example of the sensor subsidiary block 502 of FIGS. 4 and the 5. In one example implementation, the sensor detector may be or include an averaging comparator trigger and/or filter. The sensor detector may receive an input from a sensor and provide a trigger output to one or more sources such as an interrupt to the microprocessor indicating user puffing. In one example implementation, the first trigger (Trigger Out) may be defined by a square wave signal output, and the second trigger (Trigger Analog) may be defined by a signal output in which the second trigger may be an analog signal proportional to the intensity of the user's puff.

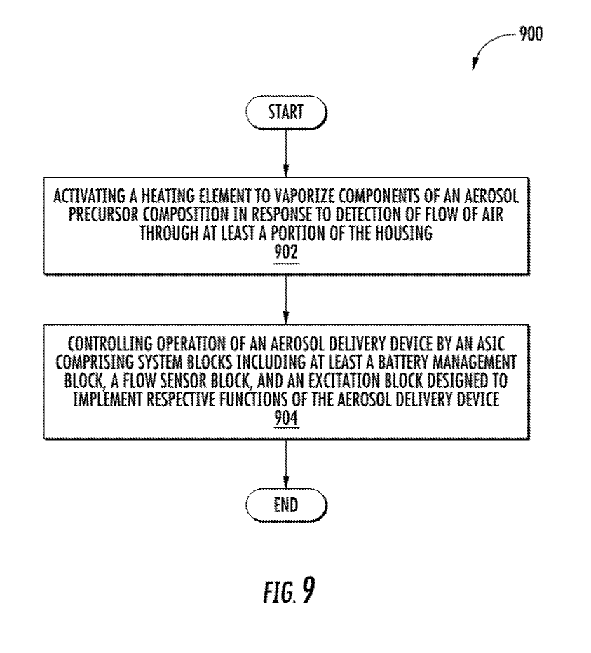

FIG. 9 illustrates various operations in a method 900 for controlling operation of an aerosol delivery according to an example implementation of the present disclosure. As shown at block 902, the method may include activating a heating element to vaporize components of an aerosol precursor composition in response to detection of flow of air through at least a portion of the aerosol delivery device housing. The air may be combinable with a thereby formed vapor to form an aerosol. As shown at block 904, the method may also include controlling operation of the aerosol delivery device by an ASIC comprising system blocks designed to implement respective functions of the aerosol delivery device. The system block may include at least a battery management block managing a battery configured to power the aerosol delivery device, a flow sensor interface block detecting the flow of air through at least the portion of the housing, and an excitation block causing activation of the heating element in response to the detection of the airflow through at least the portion of the housing.

The foregoing description of use of the article(s) can be applied to the various example implementations described herein through minor modifications, which can be apparent to the person of skill in the art in light of the further disclosure provided herein. The above description of use, however, is not intended to limit the use of the article but is provided to comply with all necessary requirements of disclosure of the present disclosure. Any of the elements shown in the article(s) illustrated in FIGS. 1-8 or as otherwise described above may be included in an aerosol delivery device according to the present disclosure.

Many modifications and other implementations of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An aerosol delivery device comprising:
at least one housing; and contained within the at least one housing,
a heating element configured to activate and vaporize components of an aerosol precursor composition in response to detection of flow of air through at least a portion of the housing, the air being combinable with a thereby formed vapor to form an aerosol; and
an application specific integrated circuit (ASIC) comprising system blocks designed to implement respective functions of the aerosol delivery device, the system blocks including at least:
a battery management block configured to manage a battery configured to power the aerosol delivery device;
a flow sensor interface block configured to detect the flow of air through at least the portion of the housing; and
an excitation block configured to cause activation of the heating element in response to an input from the flow sensor interface block that indicates the detection of the airflow through at least the portion of the housing.

2. The aerosol delivery device of claim 1, wherein the system blocks include at least one of a hardware non-programmable functional block or a programmable logic block.

3. The aerosol delivery device of claim 1, wherein the battery management block includes a control subsidiary block configured to direct power from the battery to the heating element in response to receiving an input from the flow sensor interface block that indicates the flow of air through at least the portion of the housing.

4. The aerosol delivery device of claim 1, wherein the aerosol delivery device further comprises a microprocessor, and wherein the battery management block includes a light emitting diode (LED) driver subsidiary block configured to drive an LED based at least in part on input from one or more pulse width modulators being driven by the microprocessor.

5. The aerosol delivery device of claim 1, wherein the battery includes a rechargeable battery, and the battery management block includes a thermistor subsidiary block configured to prevent the battery from being overcharged in response to a detected increase in temperature of the battery.

6. The aerosol delivery device of claim 1, wherein the battery includes a rechargeable battery, and the battery management block includes a charging subsidiary block configured to control charging the battery at a constant current based at least in part on an input voltage, the charging subsidiary block being configured to exponentially decrease the constant current as the battery approaches a full charge.

7. The aerosol delivery device of claim 1, wherein the flow sensor interface block includes a sensor subsidiary block coupled to an external flow sensor, and configured to detect the flow of air through at least the portion of the housing based at least in part on input from the flow sensor.

8. The aerosol delivery device of claim 7, wherein the aerosol delivery device further comprises a microprocessor, and wherein the flow sensor interface block further includes a regulator subsidiary block coupled to the sensor subsidiary block and configured to direct a regulated voltage to the microprocessor in response to receiving an input from the flow sensor that indicates the flow of air through the at least portion of the housing thereby disabling a transmission of power to the microprocessor prior to the detection of the flow of air through the at least portion of the housing.

9. The aerosol delivery device of claim 7, wherein the flow sensor interface block further includes a power regulation subsidiary block coupled to the sensor subsidiary block and configured to, in at least one instance, control the heating element.

10. The aerosol delivery device of claim 1, wherein the excitation block includes a linear vibrator motor driver subsidiary block configured to drive a vibrator motor in response to at least one of a detection of a low battery charge, or a detection of a low aerosol precursor composition quantity.

11. The aerosol delivery device of claim 1, wherein the excitation block includes a controlled power heater subsidiary block configured to receive an input voltage and direct power to the heating element to thereby cause activation of the heating element and control a power level of the heating element.

12. A method for controlling operation of an aerosol delivery device including at least one housing containing a heating element and an application specific integrated circuit (ASIC), the method comprising:
activating the heating element to vaporize components of an aerosol precursor composition in response to detection of flow of air through at least a portion of the housing, the air being combinable with a thereby formed vapor to form an aerosol; and
controlling operation of the aerosol delivery device by the ASIC comprising system blocks designed to implement respective functions of the aerosol delivery device, the system blocks including at least:
a battery management block managing a battery configured to power the aerosol delivery device;
a flow sensor interface block detecting the flow of air through at least the portion of the housing; and
an excitation block causing activation of the heating element in response to the detection of the airflow through at least the portion of the housing.

13. The method of claim 13, wherein the battery management block includes a control subsidiary block directing power from the battery to the heating element in response to receiving an input from the flow sensor interface block that indicates the flow of air through at least the portion of the housing.

14. The method of claim 13, wherein the aerosol delivery device further includes a microprocessor, and wherein the battery management block includes a light emitting diode (LED) driver subsidiary block driving an LED based at least in part on input from one or more pulse width modulators being driven by the microprocessor.

15. The method of claim 13, wherein the battery includes a rechargeable battery, and the battery management block includes a thermistor subsidiary block preventing the battery from being overcharged in response to a detected increase in temperature of the battery.

16. The method of claim 13, wherein the battery includes a rechargeable battery, and the battery management block includes a charging subsidiary block controlling charging the battery at a constant current based at least in part on a voltage input, the charging subsidiary block exponentially decreasing the constant current as the battery approaches a full charge.

17. The method of claim 13, wherein the flow sensor interface block includes a sensor subsidiary block coupled to an external flow sensor, and detecting the flow of air through at least the portion of the housing based at least in part on input from the flow sensor.

18. The method of claim 17, wherein the aerosol delivery device further comprises a microprocessor, and wherein the flow sensor interface block further includes a regulator subsidiary block coupled to the sensor subsidiary block and directing a regulated voltage to the heating element in response to receiving an input from the flow sensor that indicates the flow of air through the at least portion of the housing thereby disabling a transmission of power to the microprocessor prior to the detection of the flow of air through the at least portion of the housing.

19. The method of claim 17, wherein the flow sensor interface block further includes a power regulation subsidiary block coupled to the sensor subsidiary block and, in at least one instance, controlling the heating element.

20. The method of claim 13, wherein the excitation block includes a linear vibrator motor driver subsidiary block driving a vibrator motor in response to at least one of a detection of a low battery charge, or a detection of a low aerosol precursor composition quantity.

21. The method of claim 13, wherein the excitation block includes a controlled power heater subsidiary block receiving an input voltage and directing power to the heating element to thereby cause activation of the heating element and control a power level of the heating element.
